(19) United States
(12) Patent Application Publication
(10) Pub. No.: US 2009/0210115 A1
(43) Pub. Date: Aug. 20, 2009

(54) Method for the Controlled Paying-Out of a Seatbelt of a Seatbelt System and Corresponding Restraint System

(76) Inventors: Bernd Gombert, Grafrath (DE); Leopold Krausen, Regensburg (DE); Christian Zelger, Regensburg (DE)

Correspondence Address: King & Spalding LLP, 401 Congress Avenue, Suite 3200, Austin, TX, 78701, US

(21) Appl. No.: 12/279,304

(22) PCT Filed: Jan. 8, 2007
(86) PCT No.: PCT/EP07/50139

§ 371 Date: Nov. 3, 2008

(30) Foreign Application Priority Data
Feb. 14, 2006 (DE) 10 2006 006 807.6

(51) Int. Cl. B60R 21/015

(52) U.S. Cl. 701/45

(57) ABSTRACT

In a method and a restraint system for the controlled paying-out of a seatbelt (16) of a seatbelt system (1) for a vehicle (100) in the event of a crash, a vehicle occupant who is secured by the seatbelt system (1) is additionally restrained by an airbag (110), wherein the paying-out of the seat belt is controlled in such a way that the vehicle occupant (102) is braked, in particular over a predefined time period (txid) in accordance with a characteristic curve (13) to be predefined, the braking operation being such that the vehicle occupant (102) impacts against an airbag which is unfolded in an ideal fashion at the end of this time period.

### CROSS-REFERENCE TO RELATED APPLICATIONS

This application is a U.S. National Stage Application of International Application No. PCT/EP2007/050139 filed Jan. 8, 2007, which designates the United States of America, and claims priority to German Application No. 10 2006 006 807.6 filed Feb. 14, 2006, the contents of which are hereby incorporated by reference in their entirety.

### TECHNICAL FIELD

The invention relates to a method for the controlled paying-out/releasing of a belt band of a seat belt system for a vehicle in a crash situation, in which a vehicle occupant secured by means of the seat belt system is additionally restrained or caught by an airbag. The invention further relates to a corresponding restraint system and a vehicle having such a restraint system.

### BACKGROUND

Seat belt systems hitherto provided for use in motor vehicles conventionally comprise a rotatable belt reel, onto which a belt band is wound, as well as a mechanism for example in the form of a detent, centrifugal or inertial device, which in the crash situation effects a blocking of the belt reel and hence a deceleration of an unwinding movement of the belt band from the belt reel. Such systems may moreover be optionally equipped with a belt tensioner, which is attached to the belt reel or a belt lock and immediately before a crash pulls the belt tight against the body of a vehicle occupant. For preventing injuries caused by the seat belt system a belt force limiter is conventionally further provided, which limits the action of force applied by the belt band upon the vehicle occupant, for example by virtue of deformation of a torsion bar from a specific belt force on.

Given the presence of a belt tensioner, if a vehicle assist system or a crash sensor detects an imminent crash situation, a corresponding signal is transmitted to an electronic control unit, which then activates an actuating mechanism of the belt tensioner. As actuating mechanisms for the belt tensioner mechanical systems, pyrotechnic systems and reversible actuating systems using highly dynamic electric motors may be used.

The tripping of the blocking mechanism that in the crash situation effects a blocking of the belt reel may in turn be effected either mechanically or electronically by an electronic control unit, for example in response to a corresponding signal of an acceleration sensor or centrifugal force sensor. After tripping of the blocking mechanism, the force influence in the seat belt system is transmitted via a torsion bar, which, as mentioned above, deforms from a predetermined belt load on and hence limits the action of force applied by the belt band upon the vehicle occupant. Such torsion bars are usually specially designed and manufactured for a type of vehicle. In these known seat belt systems a belt force level, from which a deformation of the torsion bar and hence a limiting of the belt force is possible, is accordingly specified. It is possible to set only a maximum of two different force levels, wherein for this purpose various techniques have been developed, which operate likewise purely mechanically. There are, for example, mechanical switching devices (pyrotechnically actuated) that allow a non-recurring, irreversible switchover between two force levels. With these systems it is consequently necessary for the belt force level(s) for deformation of the torsion bar to be specified already at the design stage of the system. In this case, average values are usually used for the height and weight of a vehicle occupant, the sitting position, the driving- and crash situation etc.

There is consequently the risk, for example in the case of a vehicle occupant of a very low weight, that in the crash situation the belt force level for adequate deformation of the torsion bar will not be reached. This leads to an excessively high action of force of the belt and hence to an increased risk of injury to the head and chest area. Conversely, for example in the case of vehicle occupants of a very high weight, the decelerating effect of the belt system may be inadequate, thereby leading to the risk that in the event of a crash these persons will collide with the steering wheel.

These systems are moreover unable to respond to a variation of other parameters, such as for example an incorrect position of a vehicle occupant (“out of position”) or specific driving- or crash situations.

For this reason, in the previously filed German patent application DE 10 2005 041 101.0 of the applicant that was not yet published at the time of the present application an adaptive seat belt system is proposed, which allows individual control of the action of force that in the crash situation is applied by the belt band upon a vehicle occupant. This seat belt system comprises a braking arrangement actuatable by means of an actuator (electric motor) for decelerating a movement of the belt band. This braking arrangement is equipped with an arrangement for automatically boosting the actuating force generated by the actuator. In the present case, this is advantageously a wedge braking arrangement. A detailed description of such an arrangement for an adaptive seat belt system is to be found in the description in connection with the embodiments. The actuator is moreover connected to an electronic control unit that is devised to control the actuator in dependence upon at least one occupant-specific and/or situation-specific parameter. Such parameters are for example the weight of an occupant, the sitting position of the occupant, the velocity of the motor vehicle, a crash pulse during a crash or parameters characterizing the ambient situation (for example temperature, road quality, nature of an obstacle). In dependence upon one or more of these parameters the electronic control unit determines for example a time-dependent setpoint characteristic, in accordance with which the operation of decelerating the unwinding movement of the belt band from the belt reel is controlled.

In addition to the described belt systems, airbags are used to secure and catch and/or restrain the vehicle occupant in the event of a crash. For safety reasons, the occupant in the event of a crash should not fall onto the airbag during or shortly after firing of the airbag as the explosion-like deployment of the airbag could very seriously injure the occupant. In conventional (non-adaptive) belt systems, however, personal properties (for example height, weight, posture etc.) cannot be taken into account. Accordingly, a heavy tall man (for example a so-called 95% man) will be delivered by such a belt system more quickly to the airbag than a light small woman (for example a so-called 5% woman). For this reason, modern known restraint systems comprising a belt and airbag are always a compromise solution, in which only the average person (for example 50% man) is held and guided into the airbag nearly optimally by the belt.

### SUMMARY

In a seat belt system the deceleration of the belt band movement can be designed in such a way that a vehicle occupant additionally secured by means of an airbag is protected better than before in the event of a crash.

According to an embodiment, a method for the controlled release of a belt band of a seat belt system for a vehicle in a crash situation, in which a vehicle occupant secured by means of the seat belt system is additionally restrained by an airbag, may comprise the step of: controlling the release of the belt band in such a way that the occupant over a defined period of time is decelerated in such a way that the occupant at the end of this period of time encounters an ideally deployed airbag.

According to a further embodiment, the release of the belt band can be controlled in such a way that the occupant is decelerated in accordance with a definable characteristic. According to a further embodiment, the release of the belt band can be regulated. According to a further embodiment, the characteristic can be defined in such a way that over the principal period of deceleration in the defined period of time an almost constant acceleration acts upon the occupant. According to a further embodiment, as the beginning of the defined period of time the time of a reduction of the belt tensioning of the belt band that is effected by the seat belt system in a crash situation can be selected. According to a further embodiment, as the end of the defined period of time a time, at which the airbag is in as fully inflated a state as possible, can be selected. According to a further embodiment, the initial occupant position prior to the crash situation may be determined. According to a further embodiment, an occupant displacement or the respective occupant position in the crash situation may be determined.

According to another embodiment, a restraint system for a vehicle occupant may comprise a seat belt system for the controlled release of a belt band of said seat belt system that secures the occupant and comprising an airbag for additionally restraining the vehicle occupant secured by means of the seat belt system, and means of controlling the release of the belt band in a crash situation such that the occupant over a defined period of time is decelerated in such a way that the occupant at the end of this period of time encounters an ideally deployed airbag.

According to a further embodiment, the restraint system may further comprise means of defining a characteristic for the deceleration of the occupant. According to a further embodiment, the restraint system may further comprise means of regulating the release of the belt band. According to a further embodiment, the means of controlling and/or regulating the release of the belt band may comprise means of decelerating a movement of the belt band. According to a further embodiment, for determining at least one of an initial occupant position, an occupant displacement, and the respective occupant position in the crash situation a belt-band reel-off sensor may be provided. According to a further embodiment, for determining at least one of an initial occupant position, an occupant displacement, and the respective occupant position in the crash situation one or more sitting position sensors may be disposed. According to yet another embodiment, a vehicle may be equipped with such a restraint system.

### BRIEF DESCRIPTION OF THE DRAWINGS

There now follows a detailed description of embodiments with reference to the accompanying diagrammatic figures.

These show in

FIG. 1 diagrammatically the detail of a vehicle with driver in a passenger compartment,

FIG. 2 diagrammatically the characteristic of the belt force and the characteristic of the regulated occupant acceleration as a function of time after a crash,

FIG. 3 diagrammatically the characteristic of the usable predisplacement path as a function of time up to dipping of the occupant into the front airbag,

FIG. 4 diagrammatically the detail of a vehicle with occupant and opened airbag,

FIG. 5 a diagrammatic front view of an occupant secured by means of an adaptive seat belt system,

FIG. 6 a relevant detail of an adaptive seat belt system as may be used according to an embodiment, diagrammatically in longitudinal section and

FIG. 7 diagrammatically the operating principle of a wedge brake integrated in an adaptive seat belt system.

### DETAILED DESCRIPTION

The various embodiments are described primarily using the example of a motor vehicle. It is however generally usable also in other vehicles. The various embodiments moreover proceeds from a seat belt system that is described in the introduction and allows a controlled deceleration of a belt band movement. The controlled release of the belt band is therefore to be effected here by means of controlled deceleration of the belt band movement without the invention being limited to this case. Further advantageous is an adaptive seat belt system. A possible form of implementation of such an adaptive seat belt system is described in the prior application DE 10 2005 041 101.0 cited in the introduction. It should be pointed out that the various embodiments are not limited to the form of implementation described there.

According to the various embodiments the deceleration of the belt band movement is controlled in such a way that the occupant of the vehicle is decelerated in particular in accordance with a definable characteristic for a defined period of time in such a way that the occupant at the end of this period of time encounters an ideally deployed airbag. Thus, the afore-mentioned risk of injury as a result of the explosion-like deployment of the airbag may be minimized. It has emerged that the definable period of time may be defined as a time constant. This facilitates the control or regulation of the deceleration of the belt band movement. The time constant is merely design-dependent and hence known. A dependence upon occupant- or situation parameters does not exist. As the start of this defined period of time, at the earliest the time (t₀) of the crash situation may be selected. As (adaptive) seat belt systems as a rule comprise a belt tensioner (mentioned in the introduction), it is also possible to select as the starting time the system-intrinsic time (t₂), at which a loosening of the belt tensioning sets in. From this time on, the controlled deceleration according to various embodiments of the belt band movement advantageously sets in. The time (t₃), at which the airbag is fired, is generally after the time (t₂), at which the belt tensioning is reduced. After firing of the airbag, the airbag deploys up to a maximum volume, after which it then deflates. As the end of the definable period of time it is advantageously possible to select a time, at which the airbag is in as fully inflated a state as possible. This may be the time, at which the airbag has reached the maximum volume. It is also meaningful to select this time as shortly after attainment of the maximum volume because then a particularly gentle dipping of the occupant into the airbag is possible. The expression “ideally deployed airbag” covers these described states of the airbag. Selection of the time prior to attainment of the maximum volume should be avoided as at this time the airbag has a momentum counter to the momentum of the occupant. The time, at which the airbag has its maximum volume after being fired, is known. For this reason, the end of the defined period of time (t_{Xid}) may also be permanently selected.

In an advantageous manner, the constant time difference between the onset of the belt tensioner reduction and the time of the fully inflated airbag is selected as the defined period of time.

It is advantageous if over this said period of time the occupant experiences an almost constant (negative) acceleration. In the crash situation, the occupant may be moved over a so-called predisplacement path. In the case of a motor vehicle, the usable predisplacement path (d) within the passenger compartment is limited by specific boundary conditions and means, such as for example the steering wheel position, the seat position, the posture of the driver, the backrest adjustment. Upon firing and deployment of the airbag, this predisplacement path is reduced once more (or increases again when the airbag deflates). According to the various embodiments, the clearance between the deployed airbag and the initial occupant position is utilized for the force-minimized energy reduction. To minimize the forces acting upon the occupant, as constant an occupant acceleration as possible should be achieved. This almost constant acceleration should exist over the main part of the said defined period of time, at least however over 50%, preferably over 75% of this period of time. The occupant predisplacement is controlled or regulated in such a way that the occupant dips at the ideal time into the airbag and the, in this case, strong forces acting upon the occupant are minimized.

It is meaningful to define the characteristic for the occupant and/or the displacement acceleration relative to the passenger compartment. This allows a regulation of this occupant predisplacement for example by means of a belt-band reel-off sensor. In the case of deceleration regulated in accordance with the various embodiments of the belt band movement of an adaptive seat belt system, in the time characteristic a varying belt withdrawal independently of the weight of the occupant may be enabled. For each type of person the ideal point of dipping into the airbag is defined at the time t_{p*id}, by which the usable predisplacement path, i.e. the distance between the deployed airbag and the initial occupant position has to be overcome.

In order to regulate the release and/or deceleration of the belt band, the occupant displacement and hence the belt withdrawal may be measured for example by means of a belt-band reel-off sensor. The initial occupant position may also be determined by means of this belt-band reel-off sensor. The sitting position of the occupant (position of the seat and backrest) should further be determined. A further possibility of measuring the occupant position is to determine this by means of optical sensors fitted in the passenger compartment.

According to a further embodiment, a restraint system for vehicle occupants may comprise a seat belt system for the controlled release (or deceleration of a movement) of a belt band of this seat belt system that secures the occupant and comprise an airbag for additionally securing and/or restraining the occupant secured by means of the seat belt system. The restraint system comprises means of controlling the release of the belt band in the event of a crash such that the occupant over a defined period of time is decelerated in such a way that at the end of this period of time he encounters an ideally deployed airbag. In an advantageous manner, the restraint system comprises means of regulating the release of the belt band in accordance with a characteristic, i.e. the belt withdrawal is regulated in such a way that the occupant displacement occurs in accordance with the definable characteristic within a defined period of time applied to the restraint system, so that the occupant dips at the ideal time into the airbag. The said means may advantageously be contained in the electronic control unit of the seat belt system.

To avoid repetition, with regard to the advantages and developments of such a restraint system according to various embodiments reference is made to the explanations provided above in connection with the method. Details regarding the development of the restraint system emerge also from the embodiments.

The invention further relates to a vehicle having a restraint system according to various embodiments, wherein this vehicle is in particular a motor vehicle.

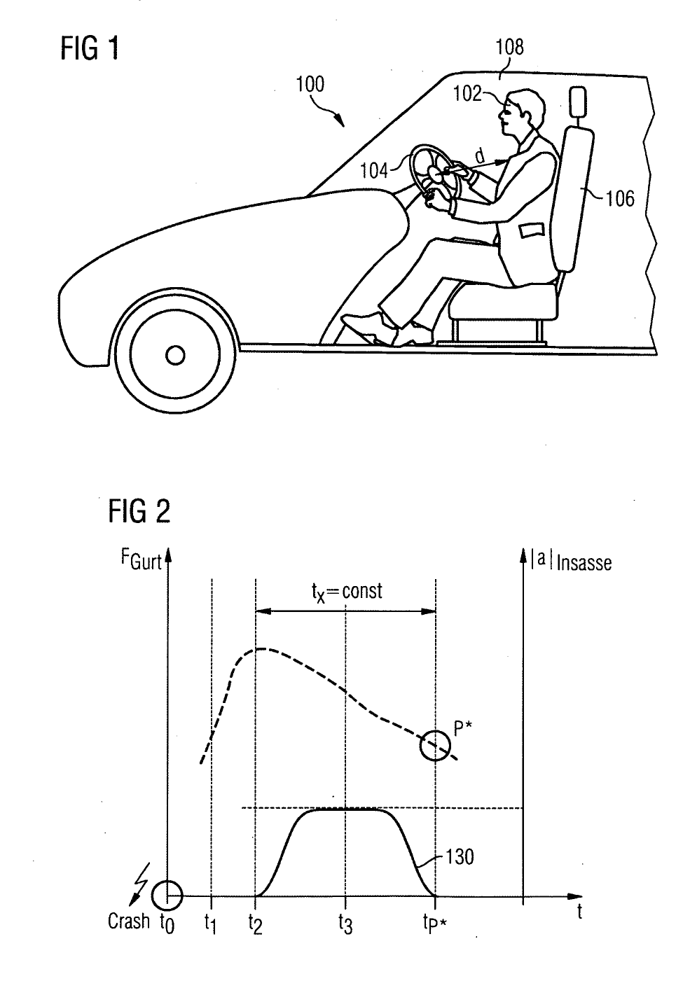

FIG. 1 diagrammatically shows the detail of a vehicle 100 with a driver or occupant 102 in a passenger compartment 108. This figure illustrates a path distance d inside the vehicle 100 that is to be defined for complete deceleration of the occupant 102, i.e. the maximum so-called predisplacement path d that is available to the occupant 102 in the crash situation without striking against vehicle parts. In the illustrated example, the steering wheel 104 is assumed to be a limiting interior part. The predisplacement path d is represented by a double arrow. It depends upon various parameters, such as the position of the steering wheel 104, the sitting position, the posture of the driver, the seat position in travel direction and the backrest position. Given a known steering wheel position, the maximum predisplacement path d may be determined by means of suitable sensor equipment. The distance may be determined for example by means of optical sensors. The sitting position of an occupant may also be determined from the measurement of a belt band position by means of an existing belt-band reel-off sensor. Sensors are moreover often available on the seat adjuster and may be used to determine the position of the occupant 102 and hence the predisplacement path d. A further possible way of detecting the sitting position of the occupant 102 is for example to provide at suitable points of the belt marks, the position of which may be tracked by means of cameras. In this way, any shortening of the available predisplacement path d may be immediately detected. A further aspect to be taken into account is that, upon firing and deployment of an airbag 110 represented in FIG. 4, the predisplacement path d is once more reduced. When the airbag 110 deflates, the predisplacement path increases again. In a, here, typically considered crash situation, the predisplacement path d is sharply reduced by deployment of the front airbag 110, as a comparison of FIGS. 1 and 4 immediately reveals.

A crash situation is now explained with reference to FIG. 2. The dashed curve in FIG. 2 reproduces the characteristic of the belt force as a function of time after a crash. The belt force is a function of the vehicle- and the occupant acceleration. What is considered is the example of a head-on collision at the time t₀. Because of the crash pulse, the occupant 102 (cf. FIG. 1) presses with increasing force against the seat belt, which at the time t₂ is tensioned by means of a belt tensioner. At the time t₁ the crash was sensed and at the time t₃ the air bag fires. At the time t_{p*} the airbag is fully inflated. So that the occupant survives the crash with as little damage as possible without being subjected by the belt and airbag to additional high loads that present a risk of injury, according to the various embodiments the belt band is paid out/released in such a way that the occupant within the constant time difference tₓ (=t_{p*}−t₂) falls into the ideally deployed airbag (at the time t_{p*}). The ideal time t_{p*} should be so selected that it coincides with or is shortly after attainment of the maximum airbag volume. A forward shift of this time may have negative repercussions as the airbag in its deployment phase exerts an additional force against the occupant.

In FIG. 2, as a characteristic curve, an acceleration characteristic 130 for the occupant 102 to be decelerated is plotted as an amount (it is a case of negative acceleration values). It is evident that over most of the period of time tₓ the acceleration of the occupant is almost constant. This has the advantage that the forces acting upon the occupant are minimized. Other characteristics, in particular characteristics adapted to the vehicle and/or the vehicle acceleration may also be used.

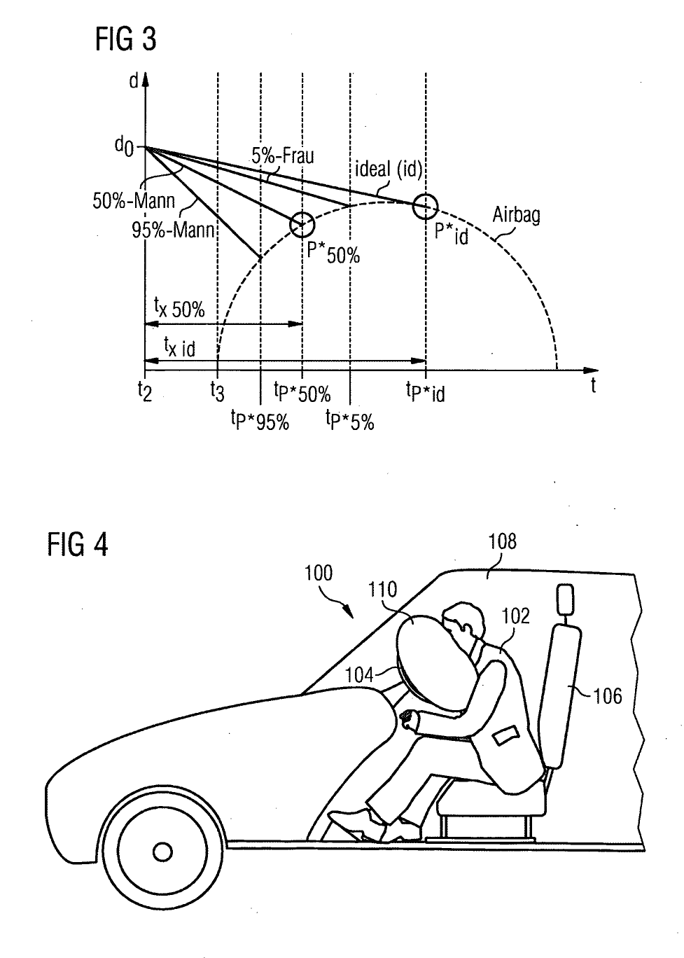

FIG. 3 illustrates by way of example the usable predisplacement path d from the time t₂ (reduction of the belt tensioning by the seat belt system) up to a time t_{p*}, at which the occupant dips into the airbag, after the airbag has fired at the time t₃. Because of the deployment of the airbag, the usable predisplacement path d initially reduces and then increases again when the airbag deflates. What is represented is the characteristic in conventional systems for three types of person (95% man, 50% man, 5% woman). In such non-adaptive restraint systems the time, at which the occupant dips into the airbag, varies in dependence upon the personal properties (in particular the weight) of the occupant. Accordingly, the 95% man dips into the airbag earlier than the 50% man or the 5% woman (cf. times t_{p*95%}, t_{p*50%}, t_{p*5%}). As such systems may not be tuned for each type of person, they are designed as a rule for the 50% man. Consequently, with this compromise solution the heavy 95% man has a shorter predisplacement path d, therefore dips into the airbag earlier than the 50% man and is at greater risk of injury from the airbag because it is possibly still deploying (as shown in FIG. 3). Since with such systems however the 5% woman, who has a much longer predisplacement path, likewise still has to be caught by the airbag, the compromise solution is also not the optimum solution for the 50% man, as is represented in FIG. 3. The 50% man namely likewise encounters the airbag when it is not yet ideally deployed. The dipping point of the compromise solution P*50% therefore lies between the two extremes 95% man and 5% woman. For persons located outside of this band there is an even higher risk of injury from the restraint system.

According to the various embodiments an ideal dipping point P*_{id} is selected. This lies at the point of the maximum airbag volume or shortly thereafter. Associated with the dipping point P*_{id} is the time t_{p*id}. The difference t_{p*id}−t₂ (time of the belt tensioning reduction) is defined as period of time t_{x id}. In the present case, this is a time constant that is used for all types of person. The regulation of the belt deceleration is effected in such a way that over the period of time t_{x id} each type of person is ideally decelerated with constant (negative) acceleration in order to dip into the airbag when it has already reached its maximum volume or is already beginning to deflate.

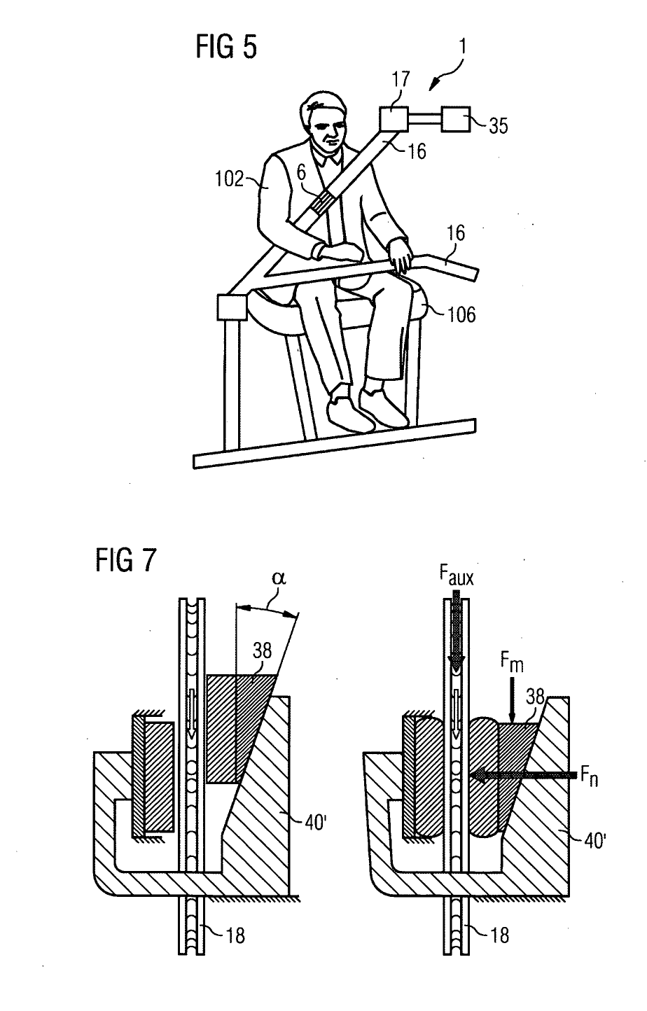

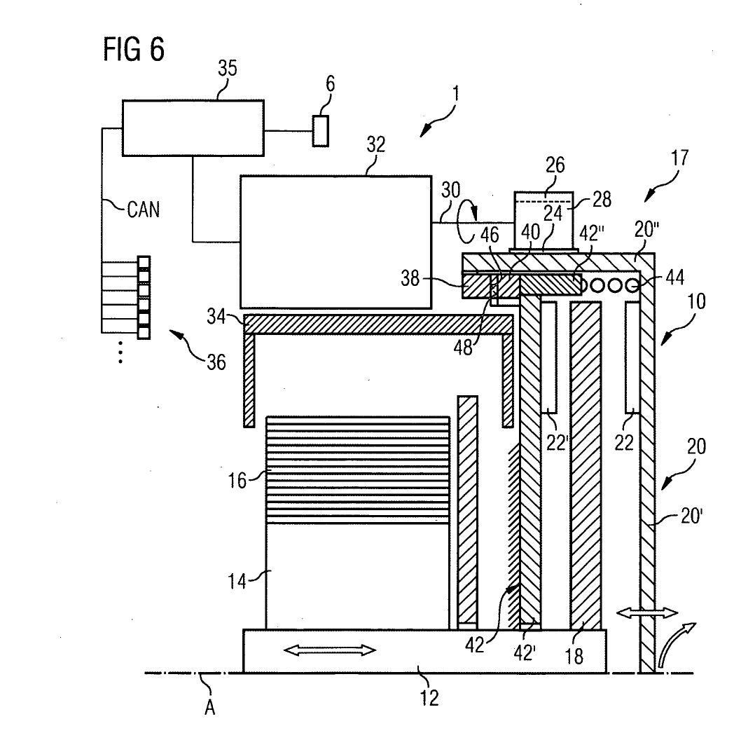

FIG. 5 shows a diagrammatic front view of an occupant 102 secured by means of an adaptive seat belt system 1. The braking arrangement 17 and the control unit 35 of the adaptive seat belt system 1 (cf. FIG. 6) are diagrammatically indicated. Also shown is the belt band 16, which extends over the upper body and the legs of the occupant 102. The occupant 102 is in a sitting position on a vehicle seat 106. For determining the occupant position, a marker 6 for example may be provided on the belt band 16, wherein the spatial position of the marker 6 may be detected for example by means of optical sensors situated in the passenger compartment 108.

FIG. 6 shows a longitudinal section of a portion, situated at one side of an axis of rotation A, of a belt retractor 10 for a possible adaptive seat belt system 1. The belt retractor 10 comprises a belt reel 14, which is disposed in a rotationally fixed manner on a float-mounted shaft 12 and onto which a belt band 16 is wound. For winding and unwinding the belt band 16 onto and from the belt reel 14, the shaft 12 having the belt reel 14 is rotatable about the axis of rotation A.

A braking arrangement 17 for decelerating an unwinding movement of the belt band 16 from the belt reel 14 comprises a brake disk 18, which is disposed coaxially with the belt reel 14 in a rotationally fixed manner on the shaft 12 and is therefore rotatable jointly with the belt reel 14 about the axis of rotation A. A first carrier part 20 comprises a first portion 20′, which extends substantially parallel to the brake disk 18 and at its side facing the brake disk 18 carries a first friction element 22. A second portion 20″ of the first carrier part 20 extends substantially at right angles to the first portion 20′ around the outer circumference of the brake disk 18. The first carrier part 20 is mounted by means of a bearing, which is not shown in FIG. 6, so as to be displaceable along the axis of rotation A and rotatable about the axis of rotation A.

On its outer circumference the second portion 20″ of the first carrier part 20 is provided with external gearing 24 that interacts with external gearing 26 of a gearwheel 28. The gearwheel 28 is connected in a rotationally fixed manner to a motor shaft 30 of an electric motor 32, wherein the electric motor 32 is positioned radially outside of the belt reel 14 and is fastened to a stationary housing part 34 that overlaps the belt reel 14.

The electric motor 32 is connected to an electronic control unit 35, which in turn is connected by a CAN bus system to sensors 36 for acquiring occupant-specific and situation-specific parameters, i.e. sensors for acquiring the weight and position of the occupant as well as velocity sensors, temperature sensors, crash sensors, acceleration sensors, centrifugal force sensors etc. The sensors 36 may be sensors that are in any case provided in a motor vehicle equipped with a belt retractor 10, for example sensors used to control the brake system. Alternatively, however, the sensors 36 may be separate sensors connected only to the electronic control unit 35 of the belt retractor 10.

A number of first wedges 38 are fastened to the second portion 20″ of the first carrier part 20 so as to be distributed around an inner circumference of the second portion 20″ of the first carrier part 20. A number—corresponding to the number of first wedges 38—of second wedges 40 are fastened to an outer surface—remote from the brake disk 18—of a stationary second carrier part 42 that is connected to the housing part 34. The first and second wedges 38, 40 in this case are oriented in such a way that their oblique wedge surfaces 46, 48 face one another and extend substantially at right angles to the axis of rotation A.

On its side facing the brake disk 18, a first portion 42′ of the second carrier part 41 that extends substantially parallel to the brake disk 18 carries a second friction element 22′. For adjusting a clearance between the first portion 20′ of the first carrier part 20 and the first portion 42′ of the second carrier part 42 a resetting spring 44 is provided, the ends of which are supported against the first portion 20′ of the first carrier part 20 and against a second portion 42″ of the second carrier part 42 that extends substantially at right angles to the first portion 42′.

There now follows a functional description of the belt retractor 10. During normal operation of the belt retractor 10 the belt band 16 is wound onto and unwound from the belt reel 14 by virtue of the shaft 12 and the belt reel 14 connected in a rotationally fixed manner thereto rotating about the axis of rotation A. Upon rotation of the shaft 12 the brake disk 18, which is likewise disposed in a rotationally fixed manner on the shaft 12, is likewise rotated about the axis of rotation A.

If the drive assist system or a corresponding sensor 36, such as for example a crash sensor, identifies a hazardous situation or an imminent crash, the electronic control unit 35 first activates a belt tensioner—if provided, whereupon the actuating mechanism of the belt tensioner brings about a rotation of the shaft 12 and hence of the belt reel 14 and the brake disk 18 about the axis of rotation A. As a result, the belt band 16 is wound onto the belt reel 14 and the belt band 16 is pulled tight against the body of the vehicle occupant.

During the crash itself, first the rotational movement of the shaft 12, the belt reel 14 and the brake disk 18 that is brought about by the belt tensioner is stopped as a result of the force acting upon the belt band 16. In order to prevent a rotation of the shaft 12, the belt reel 14 and the brake disk 18 in the opposite direction and hence an unwinding of the belt band 16 from the belt reel 14, the electric motor 32 then has to be actuated by the electronic control unit 35.

For this purpose, the electronic control unit 35 regulates the deceleration of the belt band 16 in accordance with an acceleration characteristic 130 for the occupant 102 that is defined in accordance with the various embodiments. The initial occupant position and the occupant position during the crash may—as already mentioned—be detected by corresponding sensors 6, 36 and correspondingly processed in the electronic control unit 35. The period of time available for the controlled deceleration, t_{Xid}, is defined and applied as a time constant to the control unit 35. The control unit 35 activates the electric motor 32 in such a way that the occupant displacement is effected with constant acceleration (relative to the passenger compartment) within this time constant, so that the occupant 102 dips at the ideal time into the airbag.

During the actuation of the electric motor 32 a rotation of the motor shaft 30 in clockwise direction is transmitted via the gearwheel 28 to the first carrier part 20. The first carrier part 20 is therefore twisted in clockwise direction about the axis of rotation A relative to the second carrier part 42. As a result of this, the oblique wedge surfaces 46 of the first wedges 38 fastened to the second portion 20″ of the first carrier part 20 run onto the oblique wedge surfaces 48 of the second wedges 40 fastened to the second carrier part 42, with the result that the first carrier part 20 is displaced counter to the action of the resetting spring 44 axially in the direction of the brake disk 18, i.e. in FIG. 6 to the left, so that the first friction element 22 is applied against the brake disk 18.

Although the wedge arrangement shown in FIG. 6 comprises a first and a second wedge 38, 40, the second wedge 40 may alternatively be replaced by some other suitable device, such as for example a bolt that enables a sliding or rolling support of the first wedge 38. Such a suitable device may also be the abutment 40′ that is represented in FIG. 7 and slidingly supports the wedge 38.

When the first friction element 22 is applied against the brake disk 18, the brake disk 18 owing to the float mounting of the shaft 12 is displaced jointly with the first carrier part 20 in the direction of the second carrier part 42, i.e. in FIG. 6 to the left. Consequently, the brake disk 18 is applied almost without delay also against the second friction element 22′.

In the case of the belt retractor 10 shown in FIG. 6, the first carrier part 20, the second carrier part 42 as well as the first and second wedges 38, 40 form a self-boosting arrangement, i.e. the actuating force introduced by the electric motor 32 via the gearwheel 28 is boosted automatically, without any further forces having to be introduced from outside.

FIG. 7 diagrammatically shows the operating principle of an alternative wedge arrangement, which is integrated in an adaptive seat belt system and in which a wedge 38 is slidingly supported by an abutment 40′.

Wedge brakes are known as such. For this reason, in the following only the basic operation of a wedge brake is described. With the aid of an electric drive the position of the wedge 38 may be regulated by means of the actuator force Fₘ. If the belt band 16 is being withdrawn, the disk 18 rotates. In order then to regulate the withdrawal, the belt band movement is decelerated in that the disk 18 is braked with the aid of the wedge 38. In the direction of the disk 18 the wedge 38 has a lining. The abutment 40′ in a known manner is of a floating design. The braking of the disk gives rise to a driving effect that acts on the wedge 38. This is referred to as the already described self-boosting. It allows the disk 18 to be effectively braked with minor application of force on the part of the electric drive (actuator). When μ is the coefficient of friction between lining and disk, α the wedge angle and Fₐᵤₓ the brake force, from the relationship between brake force and the normal force Fₙ to Fₐᵤₓ=μ*Fₙ this produces for the actuator force Fₘ:

$${F}_{m} = {F}_{aux} ⋆ \frac{tan α - μ}{μ} .$$

The wedge brake represented in FIG. 7 may be used to particular advantage in an adaptive seat belt system of the type described for example in FIG. 6.

What is claimed is:

1. A method for the controlled release of a belt band of a seat belt system for a vehicle in a crash situation, in which a vehicle occupant secured by means of the seat belt system is additionally restrained by an airbag, the method comprising the step of:
controlling the release of the belt band in such a way that the occupant over a defined period of time is decelerated in such a way that the occupant at the end of this period of time encounters an ideally deployed airbag.

2. The method according to claim 1, wherein the release of the belt band is controlled in such a way that the occupant is decelerated in accordance with a definable characteristic.

3. The method according to claim 1, wherein the release of the belt band is regulated.

4. The method according to claim 2, wherein the characteristic is defined in such a way that over the principal period of deceleration in the defined period of time an almost constant acceleration acts upon the occupant.

5. The method according to claim 1, wherein as the beginning of the defined period of time the time of a reduction of the belt tensioning of the belt band that is effected by the seat belt system in a crash situation is selected.

6. The method according to claim 1, wherein as the end of the defined period of time a time, at which the airbag is in as fully inflated a state as possible, is selected.

7. The method according to claim 1, wherein the initial occupant position prior to the crash situation is determined.

8. The method according to claim 1, wherein an occupant displacement or the respective occupant position in the crash situation is determined.

9. A restraint system for a vehicle occupant comprising a seat belt system for the controlled release of a belt band of said seat belt system that secures the occupant and comprising an airbag for additionally restraining the vehicle occupant secured by means of the seat belt system, and
means of controlling the release of the belt band in a crash situation such that the occupant over a defined period of time is decelerated in such a way that the occupant at the end of this period of time encounters an ideally deployed airbag.

10. The restraint system according to claim 9, comprising means of defining a characteristic for the deceleration of the occupant.

11. The restraint system according to claim 9, comprising means of regulating the release of the belt band.

12. The restraint system according to claim 9, wherein the means of controlling the release of the belt band comprise means of decelerating a movement of the belt band.

13. The restraint system according to claim 9, wherein for determining at least one of an initial occupant position, an occupant displacement, and the respective occupant position in the crash situation a belt-band reel-off sensor is provided.

14. The restraint system according to claim 9, wherein for determining at least one of an initial occupant position, occupant displacement, and the respective occupant position in the crash situation one or more sitting position sensors are disposed.

15. A vehicle having a restraint system for a vehicle occupant comprising a seat belt system for the controlled release of a belt band of said seat belt system that secures the occupant and comprising an airbag for additionally restraining the vehicle occupant secured by means of the seat belt system, and
means of controlling the release of the belt band in a crash situation such that the occupant over a defined period of time is decelerated in such a way that the occupant at the end of this period of time encounters an ideally deployed airbag.

16. The vehicle according to claim 15, comprising means of defining a characteristic for the deceleration of the occupant.

17. The vehicle according to claim 15, comprising means of regulating the release of the belt band.

18. The vehicle according to claim 15, wherein the means of controlling the release of the belt band comprise means of decelerating a movement of the belt band.

19. The vehicle according to claim 15, wherein for determining at least one of an initial occupant position, an occupant displacement, and the respective occupant position in the crash situation a belt-band reel-off sensor is provided or one or more sitting position sensors are disposed.

20. The restraint system according to claim 11, wherein the means of regulating the release of the belt band comprise means of decelerating a movement of the belt band
